(19) United States
(12) Patent Application Publication
(10) Pub. No.: US 2009/0072570 A1
(43) Pub. Date: Mar. 19, 2009

(54) LIFTGATE GUIDE COLUMN COVER AND SERVICE ACCESS

(76) Inventor: Peter J. Savoy, Akron, OH (US)

Correspondence Address: Emerson, Thomson & Bennett, LLC, 777 W. Market Street, Akron, OH, 44303, US

(21) Appl. No.: 12/133,764

(22) Filed: Jun. 5, 2008

Related U.S. Application Data
(60) Provisional application No. 60/942,060, filed on Jun. 5, 2007.

(51) Int. Cl. B62D 25/08; E05F 11/00

(52) U.S. Cl. 296/56; 49/360

(57) ABSTRACT

A liftgate guide column cover may be used to cover and protect a liftgate guide column and thus the liftgate components within it, and also used to provide access to the guide column and the liftgate components within it. In one embodiment, the cover pivots between a closed and an open condition. In another embodiment, the cover can be attached and detached from the guide column.

This application claims priority to U.S. Ser. No. 60/942,060, entitled LIFTGATE GUIDE COLUMN COVER AND SERVICE ACCESS, filed Jun. 5, 2007, which is incorporated herein by reference.

### I. BACKGROUND OF THE INVENTION

A. Field of Invention

This invention pertains to the art of methods and apparatuses regarding liftgates and more specifically to methods and apparatuses regarding the manufacture and use of liftgate guide columns.

B. Description of the Related Art

It is well known in the art to attach liftgates to vehicle trailers or other forms of vehicle cargo holds to assist with loading and unloading of the vehicles. In general, liftgates include a cargo platform or deck and an adjustment system used to move the cargo platform. To load cargo from a ground surface to the vehicle's cargo floor, the cargo platform is positioned in a deployed or lowered position where it is generally parallel with the ground surface. The cargo can then be easily placed onto the cargo platform. The cargo platform is then lifted to a raised position generally parallel with the vehicle's cargo floor. The cargo can then be easily loaded into the vehicle. To unload cargo from the vehicle, the reverse steps are taken.

Various types and styles of liftgates are known in the art. Some non-limiting examples include conventional liftgates, flip-a-way or fold-up liftgates, rail type liftgates, and special purpose liftgates. FIG. 1 shows a known rail type liftgate system and provides a list of the major components. FIG. 2 illustrates the basic operation of a liftgate system. Note that the uprights 1, 12 (hereafter “liftgate guide columns”), which receive runners 8, 16, are substantially solid and self-enclosed. Access to the interior channel of the guide column is limited to a contiguous opening wherein the runners move up and down to raise and lower an attached platform, and to a small opening at the top of the guide column. While the liftgate guide columns 1, 12 shown in FIG. 1 work well for their intended purpose, such liftgate guide columns have a disadvantage.

The disadvantage is related to the fact that various liftgate components, which may include, for example, control wiring, hydraulic system components, switches, lights, etc. are positioned within the liftgate guide columns. Should any of these liftgate components require service or maintenance, they are difficult to access.

The present invention provides methods and apparatuses to provide easy access to the liftgate components that are positioned within a liftgate guide column while still providing protection for the liftgate components. This invention thus overcomes the foregoing difficulties and others while providing better and more advantageous overall results.

### II. SUMMARY OF THE INVENTION

According to one embodiment of this invention, a liftgate comprises: (A) at least one attachment surface that can be attached to an associated vehicle having a cargo receiving floor; (B) a cargo platform having a cargo receiving surface; (C) a first runner operatively connected to the cargo platform; (D) a first liftgate guide column comprising: (1) a top, a bottom, and a mid-portion; (2) a channel that receives at least a portion of the first runner; (3) a first access opening formed in the mid-portion that provides access to the interior of the first liftgate guide column; (E) a first cover that is pivotally connected to the first liftgate guide column and is manually pivotal between: (1) a first position where the first cover covers the first access opening and prevents access through the first access opening; and, (2) a second position where the first cover does not cover the first access opening and permits access through the first access opening; and, (F) an adjustment system that moves the first runner within the channel in the first liftgate guide column between: (1) a relatively raised position where the cargo receiving surface of the cargo platform is substantially parallel with the cargo receiving floor of the vehicle; and, (2) a relatively lowered position where the cargo receiving surface of the cargo platform is substantially below the cargo receiving floor of the vehicle.

According to one embodiment of this invention, a liftgate comprises: (A) at least one attachment surface that can be attached to an associated vehicle having a cargo receiving floor; (B) a cargo platform having a cargo receiving surface; (C) a first runner operatively connected to the cargo platform; (D) a first liftgate guide column comprising: (1) a top, a bottom, and a mid-portion; (2) a channel that receives at least a portion of the first runner; (3) a first access opening formed in the mid-portion that provides access to the interior of the first liftgate guide column; (E) a first connection apparatus comprising: a first sleeve; and, a first pin; (F) a first cover that is: (1) manually attachable to the first liftgate guide column where the first cover covers the first access opening and prevents access through the first access opening by insertion of the first pin within the first sleeve; and, (2) manually detachable from first liftgate guide column where the first cover does not cover the first access opening and permits access through the first access opening by removal of the first pin from the first sleeve; and, (F) an adjustment system that moves the first runner within the channel in the first liftgate guide column between: (1) a relatively raised position where the cargo receiving surface of the cargo platform is substantially parallel with the cargo receiving floor of the vehicle; and, (2) a relatively lowered position where the cargo receiving surface of the cargo platform is substantially below the cargo receiving floor of the vehicle.

According to still another embodiment of this invention, a liftgate comprises: (A) at least one attachment surface that can be attached to an associated vehicle having a cargo receiving floor; (B) a cargo platform having a cargo receiving surface; (C) first and second runners operatively connected to the cargo platform; (D) a first liftgate guide column comprising: (1) a top, a bottom, and a mid-portion; (2) a channel that receives at least a portion of the first runner; (3) a first access opening formed in the mid-portion that provides access to the interior of the first liftgate guide column; (E) a second liftgate guide column comprising: (1) a top, a bottom, and a mid-portion; (2) a channel that receives at least a portion of the second runner; (3) a first access opening formed in the mid-portion that provides access to the interior of the second liftgate guide column; (F) a first cover that is pivotally connected to the first liftgate guide column and is manually pivotal between: (1) a first position where the first cover covers the first access opening in the first liftgate guide column and prevents access through the first access opening in the first liftgate guide column; and, (2) a second position where the first cover does not cover the first access opening in the first liftgate guide column and permits access through the first access opening in the first liftgate guide column; (G) a first connection apparatus that connects the first cover to the first liftgate guide column, the first connection apparatus comprising: a first sleeve that rotatably receives a first pin; (H) a second cover that is pivotally connected to the second liftgate guide column and is manually pivotal between: (1) a first position where the second cover covers the first access opening in the second liftgate guide column and prevents access through the first access opening in the second liftgate guide column; and, (2) a second position where the second cover does not cover the first access opening in the second liftgate guide column and permits access through the first access opening in the second liftgate guide column; (I) a second connection apparatus that connects the second cover to the second liftgate guide column, the second connection apparatus comprising: a second sleeve that rotatably receives a second pin; and, (J) an adjustment system that moves the first and second runners within the channel in the first liftgate guide column and the channel in the second liftgate guide column, respectively, between: (1) a relatively raised position where the cargo receiving surface of the cargo platform is substantially parallel with the cargo receiving floor of the vehicle; and, (2) a relatively lowered position where the cargo receiving surface of the cargo platform is substantially below the cargo receiving floor of the vehicle.

One advantage of this invention is that it is easy to access liftgate components positioned within a liftgate guide column.

Another advantage of this invention is that the liftgate components positioned within the liftgate guide column are well protected.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a plan perspective view of a prior art rail type liftgate.

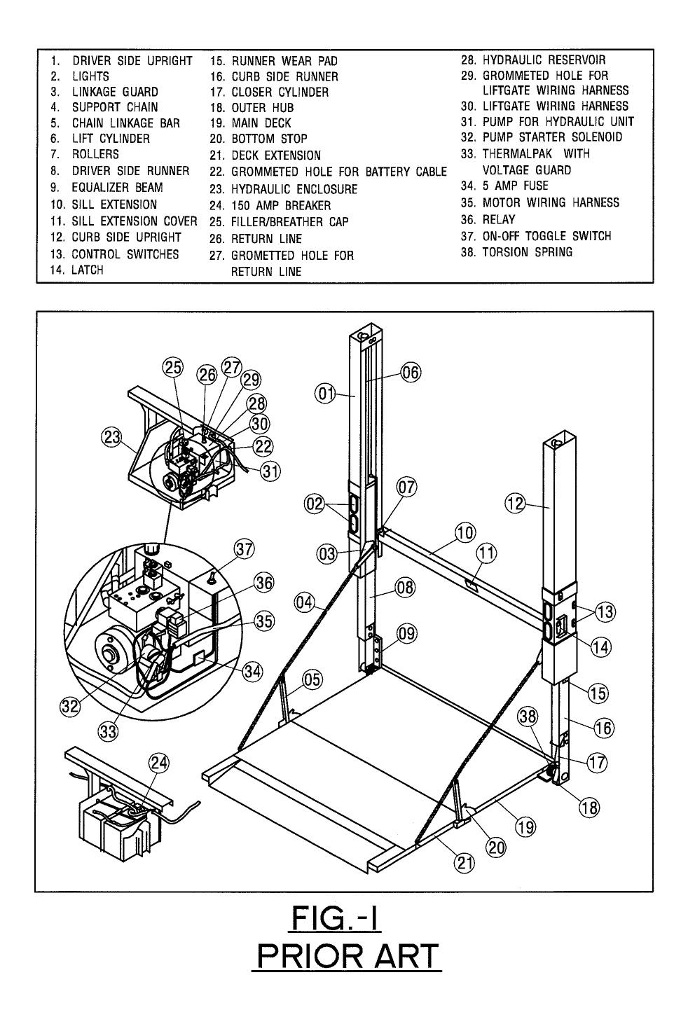

FIG. 2 illustrates the general operation of a liftgate system.

FIG. 3 is a perspective view of a curb side liftgate guide column according to one embodiment of this invention.

FIG. 4 is a close-up view of the top portion of the liftgate guide column shown in FIG. 3.

FIG. 5 is a perspective view of one embodiment of the invention that is attached to a vehicle trailer.

### IV. DETAILED DESCRIPTION OF THE INVENTION

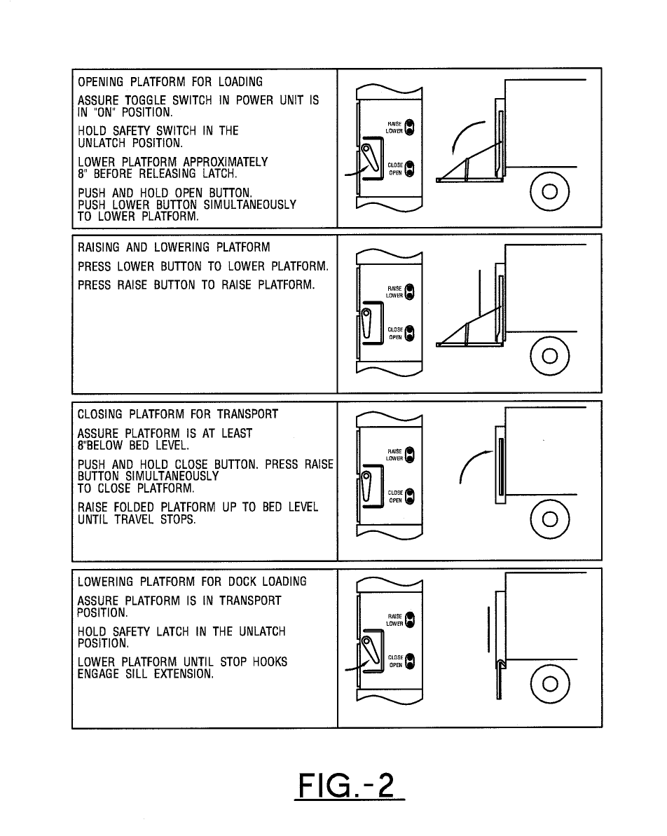

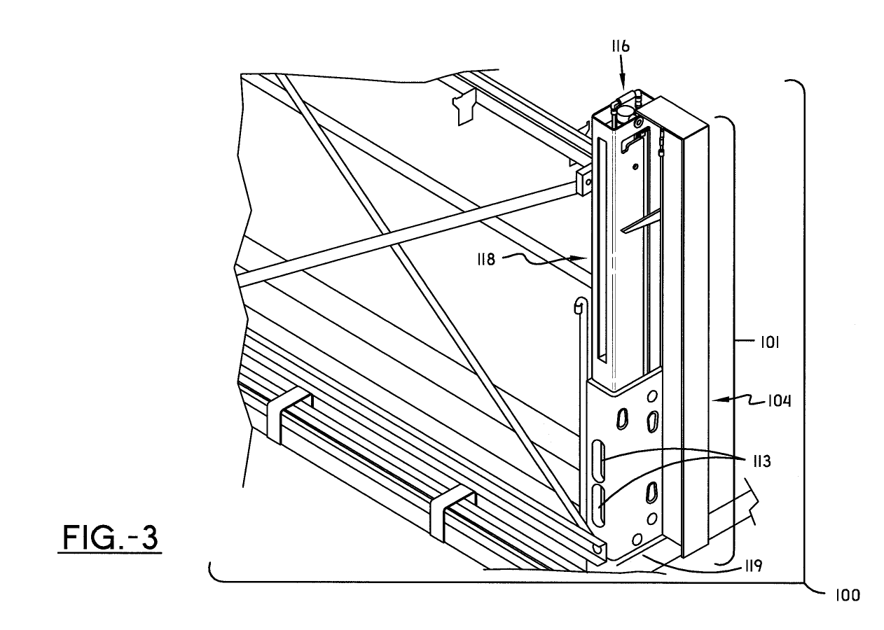

Referring now to the drawings wherein the showings are for purposes of illustrating embodiments of the invention only and not for purposes of limiting the same, FIG. 3 shows a liftgate apparatus 100 using a pair of column covers 104 according to one embodiment of this invention. The overall operation of a rail type liftgate apparatus is as provided in FIG. 2, and thus will not be described in detail.

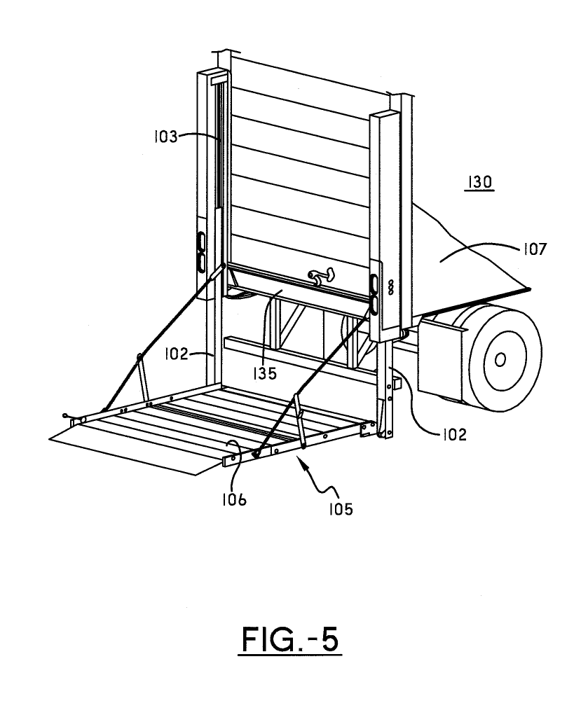

With reference now to FIGS. 3, 4, and 5, the liftgate apparatus 100 may have a cargo receiving platform 105 and at least one attachment surface 135 for use in connecting the liftgate apparatus 100 to an associated vehicle 130 which may have a cargo receiving floor 107. The particular type and manner in which the attachment surface 135 is used can be any manner known in the art and thus will not be described further here. The liftgate apparatus 100 may also at least one runner 102 (two shown) that pivotally attaches to the platform 105, at least one liftgate guide column 101 (two shown) that slidably receives the runner 102 in a known manner, and an adjustment system 103 for use in adjusting the position of the cargo platform 105. A guide column cover 104 may be used to cover and protect each guide column 101, and thus the components within it, but also to provide access to each guide column 101 as will be discussed further below.

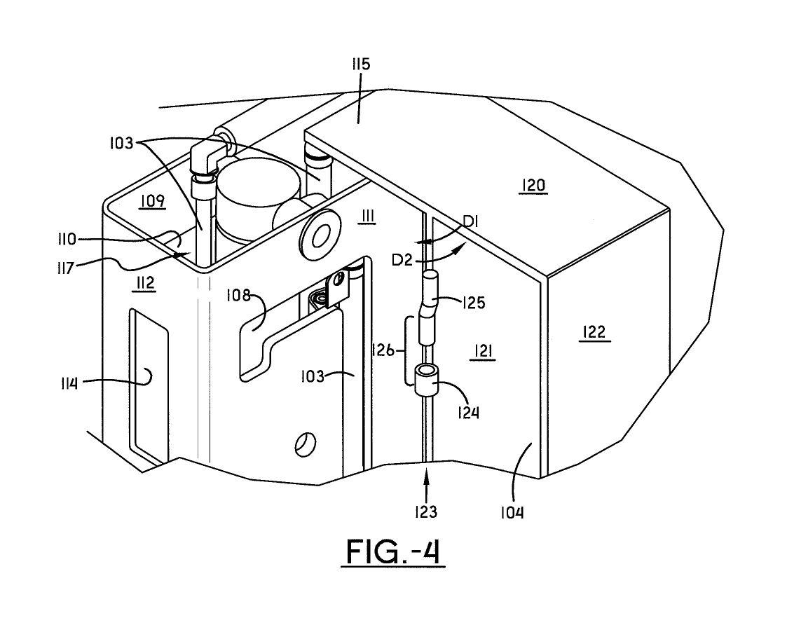

With reference now to FIGS. 3 and 4, the adjustment system 103 may be of any type chosen with the sound judgment of a person of skill in the art, and may include, for a non-limiting example, a hydraulic system (not shown) and a control system (not shown). As these systems, and similar systems, are well know, further details will not be provided here. However, some of liftgate adjustment system 103 components may be positioned within and/or supported on the liftgate guide column 101, including, for example control wiring, hydraulic system components, and control switches. Additional liftgate components may also be positioned within and/or supported on the liftgate guide column 101 including, for one non-limiting example, lights.

The adjustment system 103 may be used to adjust the cargo platform 105 between a stored or stowed condition and a deployed or use condition. When the cargo platform 105 is in a deployed condition, the cargo platform's 105 cargo receiving surface 106 provides a planar surface for accepting cargo. The adjustment system 103 may also be used to adjust the cargo receiving surface 106 between a lowered use position, generally parallel with a ground surface, and an upper use position, generally parallel with the cargo receiving floor 107 of the vehicle 130. In this way the liftgate apparatus 100 provides an elevator device for use in moving cargo from a ground surface to a position where it is level with—and easily unloaded onto—the vehicle's cargo receiving floor 107.

The guide column embodiment shown in FIGS. 3 and 4 has a generally rectangular columnar shape but it should be understood that a guide column could take many other shapes and still fall into the scope of this invention. The embodiment shown in FIGS. 3 and 4, however, is a generally rectangular columnar shape that includes a top 116 (shown with an access opening 117), a bottom 119, and a mid-portion 118 consisting of two vertical side walls and two vertical end walls. In several embodiments of this invention, where the liftgate guide column 101 has a length of LG1, and the length of the cover 104 is C1, the ratio of C1/LG1 may be either: 0.5, 0.75, or substantially 1.0 for one or both sets of guide columns 101 and covers 104. A first side wall 109 has a channel 110 extending from near the top 116 of the guide column 101 to nearly the bottom 119 of the guide column 101. The runner 102 freely moves up and down within this channel 110 when raising and lowering the attached cargo platform 105. A second side wall 111 has at least one, two shown, access openings 108 that allow easy service or maintenance access to the various adjustment system 103 components positioned within the guide column 101. In several embodiments of the invention, where the length of the liftgate guide column 101 is LG1, and the length of the access opening 108 is O1, the ratio of O1/LG1 may be at least 0.1 for one or both sets of guide columns 101 and covers 104. The second side wall 111 may contain any number of additional access openings 108, as needed. A first end wall 112 may have openings for taillights 113 mounted within the guide column 101, and in the embodiment shown in FIG. 3 it also has additional access openings 114 (six shown). The first end wall may contain any number of additional access openings 114, as needed. A second end wall 115 abuts, and may or may not be attached to, the rear end of the vehicle 130.

When the guide column cover 104 is attached to the outside surface of the guide column 101, it provides: (1) when in a closed or attached position, protection to the adjustment system 103 components; and, (2) when in an open or removed position, easy access—via access openings 108, 114, and/or 117—to the liftgate components housed within or supported by the guide column 101. While the guide column cover 104 can have any shape chosen with the sound judgment of a person of skill in the art, in the embodiment shown in FIGS. 3 and 4, the cover 104 has a top portion 120 to protect the top 116 of the guide column 101, a side portion 121 to protect the second side wall 111 of the guide column 103, and an end portion 122 to protect the first end wall 112 of the guide column 101. When attached and closed, the guide column cover 104 fully shields the access openings 108, 114, and/or 117 located on the second side wall 109, first end wall 111, and/or top of the guide column 101—and thus protects the various liftgate components positioned within or supported by the guide column 101.

With continuing reference to FIGS. 3 and 4, the guide column cover 104 may be attached to the guide column 101 in any manner chosen with the sound judgment of a person of skill in the art. In one embodiment, the cover 104 is pivotally connected to the guide column 101, using a hinge or hinges. The cover 104 may then be manually pivoted between a closed (first) position where the access openings 108, 114, and/or 117 are covered and not accessible, and an open (second) position where the access openings 108, 114, and/or 117 are not covered and are fully accessible. In another embodiment, a connection mechanism 123 comprising a sleeve 124 and a pin 125 that is received within the sleeve 124 is used. For this embodiment, the connection mechanism 123 provides both a pivotal connection for the cover 104 and also provides for an easy way to detach and remove the cover 104 away from the guide column 101. Specifically, the connection mechanism 123 may include at least one sleeve/pin connection 126, two shown, where a pin 125 is received within a sleeve 124, and thus the pin 125 can be rotated within the sleeve 124. In one embodiment, as shown in FIGS. 3 and 4, the sleeve 124 is attached to the guide column 101 and the pin 125 is attached to the cover 104. In another embodiment, not shown, the pin 125 is attached to the guide column 101 while the sleeve 124 is attached to the cover 104. In yet another embodiment, a connection apparatus 123 consisting of a sleeve 124 and a pin 125 provides easy attachment and detachment of the cover 104 to the guide column 101 when the pin 125 is selectively inserted or removed from an opening in the sleeve 124. In yet another embodiment, shown in FIGS. 3 and 4, the connection apparatus 123 provides both easy attachment and detachment of the cover 104 to the guide column 101 and pivotal attachment of the cover 104 to the guide column 101. The number of sleeve/pin connections 126 used may vary depending on the sound judgment of a person of skill in the art.

With continuing reference to FIGS. 3 and 4, the cover 104 may be attached to the guide column 101 by lifting the cover 104 and placing the pin(s) 125 within the corresponding hole(s) in the sleeve(s) 124. The cover 104 may then be easily pivoted in direction D1 about the sleeve/pin 126 connection between an open position, shown in FIGS. 3-4, to a closed position (not shown) where the various service openings 108, 114, and/or 117 are shielded by the cover 104. When the cover 104 is closed, should it be desirable to access any adjustment system 103 component housed within the guide column 101, it is only necessary—depending on the particular embodiment—to either detach the cover or open the cover 104 by pivoting it about the sleeve/pin 126 in direction D2 to the open position shown in FIGS. 3-4. The various access openings 108, 114, and/or 117, are then easily used to access any liftgate component. If further access is required, the cover 104 can be easily removed by lifting the pin 126 out of the sleeve 124 in a pin/sleeve connection 122, or removing the pivot pin 128 in a sleeve/sleeve connection 127.

Though not shown, it is also contemplated to provide a closure mechanism and/or a lock mechanism to secure the cover 104 in a closed position to the guide column 101. The closure mechanism could be of any type chosen with the sound judgment of a person of skill in the art including, for some non-limiting examples, latch mechanisms, and latch/striker mechanisms similar to that commonly used with automobile trunk systems. The lock mechanism could be of any type chosen with the sound judgment of a person of skill in the art including, for some non-limiting examples, keyed locks such as those commonly found on automobile doors, deadbolt type locks, pad locks, combination locks, electric strikers, etc.

Multiple embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

I/We claim:

1. A liftgate comprising:
at least one attachment surface that can be attached to an associated vehicle having a cargo receiving floor;
a cargo platform having a cargo receiving surface;
a first runner operatively connected to the cargo platform;
a first liftgate guide column comprising:
(1) a top, a bottom, and a mid-portion;
(2) a channel that receives at least a portion of the first runner;
(3) a first access opening formed in the mid-portion that provides access to the interior of the first liftgate guide column;
a first cover that is pivotally connected to the first liftgate guide column and is manually pivotal between: (1) a first position where the first cover covers the first access opening and prevents access through the first access opening; and, (2) a second position where the first cover does not cover the first access opening and permits access through the first access opening; and,
an adjustment system that moves the first runner within the channel in the first liftgate guide column between: (1) a relatively raised position where the cargo receiving surface of the cargo platform is substantially parallel with the cargo receiving floor of the vehicle; and, (2) a relatively lowered position where the cargo receiving surface of the cargo platform is substantially below the cargo receiving floor of the vehicle.

2. The liftgate of claim 1 wherein:
the first liftgate guide column further comprises a second access opening formed in the top that that provides access to the interior of the first liftgate guide column; and,
the first cover is manually pivotal between: (1) the first position where the first cover covers the second access opening and prevents access through the second access opening; and, (2) the second position where the first cover does not cover the second access opening and permits access through the second access opening.

3. The liftgate of claim 1 wherein the first liftgate guide column has a length LG1 and the first cover has a length C1 and the ratio C1/LG1 is at least 0.5.

4. The liftgate of claim 3 wherein the ratio C1/LG1 is at least 0.75.

5. The liftgate of claim 3 wherein the ratio C1/LG1 is substantially 1.0.

6. The liftgate of claim 1 wherein the first cover is pivotally connected to the first liftgate guide column with a connection apparatus comprising:
a sleeve; and,
a pin that is received within the sleeve.

7. The liftgate of claim 6 wherein the sleeve is attached to the first liftgate guide column and the pin is attached to the first cover.

8. The liftgate of claim 6 wherein the sleeve is attached to the first cover and the pin is attached to the first liftgate guide column.

9. The liftgate of claim 1 further comprising:
a second runner operatively connected to the cargo platform;
a second liftgate guide column comprising:
(1) a top, a bottom, and a mid-portion;
(2) a channel that receives at least a portion of the second runner;
(3) a first access opening formed in the mid-portion that provides access to the interior of the second liftgate guide column;
a second cover that is pivotally connected to the second liftgate guide column and is manually pivotal between: (1) a first position where the second cover covers the first access opening of the second liftgate guide column and prevents access through the first access opening of the second liftgate guide column; and, (2) a second position where the second cover does not cover the first access opening of the second liftgate guide column and permits access through the first access opening of the second liftgate guide column; and,
wherein the adjustment system moves the second runner within the channel in the second liftgate guide column between: (1) a relatively raised position where the cargo receiving surface of the cargo platform is substantially parallel with the cargo receiving floor of the vehicle; and, (2) a relatively lowered position where the cargo receiving surface of the cargo platform is substantially below the cargo receiving floor of the vehicle.

10. The liftgate of claim 1 wherein the first liftgate guide column has a length LG1 and the first access opening has a length O1 and wherein the ratio O1/LG1 is at least 0.1.

11. A liftgate comprising:
at least one attachment surface that can be attached to an associated vehicle having a cargo receiving floor;
a cargo platform having a cargo receiving surface;
a first runner operatively connected to the cargo platform;
a first liftgate guide column comprising:
(1) a top, a bottom, and a mid-portion;
(2) a channel that receives at least a portion of the first runner;
(3) a first access opening formed in the mid-portion that provides access to the interior of the first liftgate guide column;
a first connection apparatus comprising: a first sleeve; and, a first pin;
a first cover that is: (1) manually attachable to the first liftgate guide column where the first cover covers the first access opening and prevents access through the first access opening by insertion of the first pin within the first sleeve; and, (2) manually detachable from first liftgate guide column where the first cover does not cover the first access opening and permits access through the first access opening by removal of the first pin from the first sleeve; and,
an adjustment system that moves the first runner within the channel in the first liftgate guide column between: (1) a relatively raised position where the cargo receiving surface of the cargo platform is substantially parallel with the cargo receiving floor of the vehicle; and, (2) a relatively lowered position where the cargo receiving surface of the cargo platform is substantially below the cargo receiving floor of the vehicle.

12. The liftgate of claim 11 wherein the first sleeve is attached to the first liftgate guide column and the first pin is attached to the first cover.

13. The liftgate of claim 11 wherein the first sleeve is attached to the first cover and the first pin is attached to the first liftgate guide column.

14. The liftgate of claim 11 further comprising:
a second connection apparatus comprising: a second sleeve; and, a second pin; and,
wherein the first cover is: (1) manually attachable to the first liftgate guide column where the first cover covers the first access opening and prevents access through the first access opening by insertion of the second pin within the second sleeve; and, (2) manually detachable from first liftgate guide column where the first cover does not cover the first access opening and permits access through the first access opening by removal of the second pin from the second sleeve.

15. The liftgate of claim 11 wherein:
the first liftgate guide column further comprises a second access opening formed in the top that that provides access to the interior of the first liftgate guide column; and,
the first cover is manually pivotal between: (1) the first position where the first cover covers the second access opening and prevents access through the second access opening; and, (2) the second position where the first cover does not cover the second access opening and permits access through the second access opening.
the first cover is: (1) manually attachable to the first liftgate guide column where the first cover covers the second access opening and prevents access through the second access opening by insertion of the first pin within the first sleeve; and, (2) manually detachable from first liftgate guide column where the first cover does not cover the second access opening and permits access through the second access opening by removal of the first pin from the first sleeve.

16. The liftgate of claim 11 wherein the first liftgate guide column has a length LG1 and the first cover has a length C1 and the ratio C1/LG1 is at least 0.5.

17. The liftgate of claim 11 further comprising:
a second runner operatively connected to the cargo platform;
a second liftgate guide column comprising:
(1) a top, a bottom, and a mid-portion;
(2) a channel that receives at least a portion of the second runner;
(3) a first access opening formed in the mid-portion that provides access to the interior of the second liftgate guide column;
a second cover that is: (1) manually attachable to the second liftgate guide column where the second cover covers the first access opening in the second liftgate guide column and prevents access through the first access opening in the second liftgate guide column by insertion of the first pin within the first sleeve; and, (2) manually detachable from the second liftgate guide column where the second cover does not cover the first access opening in the second liftgate guide column and permits access through the first access opening in the second liftgate guide column by removal of the first pin from the first sleeve.
wherein the adjustment system moves the second runner within the channel in the second liftgate guide column between: (1) a relatively raised position where the cargo receiving surface of the cargo platform is substantially parallel with the cargo receiving floor of the vehicle; and, (2) a relatively lowered position where the cargo receiving surface of the cargo platform is substantially below the cargo receiving floor of the vehicle.

18. The liftgate of claim 11 wherein the first liftgate guide column has a length LG1 and the first access opening has a length O1 and the ratio O1/LG1 is at least 0.1.

19. A liftgate comprising:
at least one attachment surface that can be attached to an associated vehicle having a cargo receiving floor;
a cargo platform having a cargo receiving surface;
first and second runners operatively connected to the cargo platform;
a first liftgate guide column comprising:
(1) a top, a bottom, and a mid-portion;
(2) a channel that receives at least a portion of the first runner;
(3) a first access opening formed in the mid-portion that provides access to the interior of the first liftgate guide column;
a second liftgate guide column comprising:
(1) a top, a bottom, and a mid-portion;
(2) a channel that receives at least a portion of the second runner;
(3) a first access opening formed in the mid-portion that provides access to the interior of the second liftgate guide column;
a first cover that is pivotally connected to the first liftgate guide column and is manually pivotal between: (1) a first position where the first cover covers the first access opening in the first liftgate guide column and prevents access through the first access opening in the first liftgate guide column; and, (2) a second position where the first cover does not cover the first access opening in the first liftgate guide column and permits access through the first access opening in the first liftgate guide column;
a first connection apparatus that connects the first cover to the first liftgate guide column, the first connection apparatus comprising: a first sleeve that rotatably receives a first pin;
a second cover that is pivotally connected to the second liftgate guide column and is manually pivotal between: (1) a first position where the second cover covers the first access opening in the second liftgate guide column and prevents access through the first access opening in the second liftgate guide column; and, (2) a second position where the second cover does not cover the first access opening in the second liftgate guide column and permits access through the first access opening in the second liftgate guide column;
a second connection apparatus that connects the second cover to the second liftgate guide column, the second connection apparatus comprising: a second sleeve that rotatably receives a second pin; and,
an adjustment system that moves the first and second runners within the channel in the first liftgate guide column and the channel in the second liftgate guide column, respectively, between: (1) a relatively raised position where the cargo receiving surface of the cargo platform is substantially parallel with the cargo receiving floor of the vehicle; and, (2) a relatively lowered position where the cargo receiving surface of the cargo platform is substantially below the cargo receiving floor of the vehicle.

20. The liftgate of claim 19 wherein:
the first liftgate guide column has a length LG1 and the first cover has a length C1 and the ratio C1/LG1 is at least 0.5;
the first access opening has a length O1 and the ratio O1/LG1 is at least 0.1;
the second liftgate guide column has a length LG2 and the first cover has a length C2 and the ratio C2/LG2 is at least 0.5; and,
the second access opening has a length O2 and the ratio O2/LG2 is at least 0.1.
